(19) United States
(12) Patent Application Publication
(10) Pub. No.: US 2011/0244087 A1
(43) Pub. Date: Oct. 6, 2011

(54) MICROWAVABLE COOKING IMPLEMENTS AND METHODS FOR CRISPING FOOD ITEMS USING THE SAME

(76) Inventors: Mathieu Lion, Paris (FR); Elodie Brisset, Paris (FR)

(21) Appl. No.: 12/984,557

(22) Filed: Jan. 4, 2011

Related U.S. Application Data
(63) Continuation-in-part of application No. 11/157,747, filed on Jun. 21, 2005, now Pat. No. 7,861,886.
Application No. 11/157,747 is a continuation-in-part of application No. 10/883,348, filed on Jul. 1, 2004, now Pat. No. 7,850,035.

(51) Int. Cl. A47J 27/00; A23L 1/00; A23L 1/01; A23L 1/217

(52) U.S. Cl. 426/243; 99/426; 426/523

(57) ABSTRACT

A cooking implement comprising a resilient cooking surface, a substantially rigid periphery surrounding the resilient cooking surface, a frame coupled to the substantially rigid periphery to provide a tensile force across the cooking surface and a support structure configured to provide an airspace beneath the resilient cooking surface. The microwavable cooking implement may be used to crisp a variety of food items, such as sliced potatoes to make potato chips, by laying a single layer of the food item on top of the resilient cooking surface and heating the cooking implement with the food items for a predetermined time.

### CROSS-REFERENCE TO RELATED APPLICATIONS

This application is a continuation-in-part of U.S. patent application Ser. No. 11/157,747, filed Jun. 21, 2005, now pending, which is a continuation-in-part of application Ser. No. 10/883,348, filed Jul. 1, 2004, now U.S. Pat. No. 7,850,035 issued Dec. 14, 2010. The contents of each of the foregoing applications are incorporated herein by reference in their entireties.

### FIELD OF THE INVENTION

The present disclosure relates to microwavable cooking implements and, more particularly, to a microwavable cooking implement having a resilient silicone cooking surface that permits air circulation both above and beneath the cooking surface for crisping food items.

### BACKGROUND

Potato chips are among the most popular snack food. Because potato chips are typically deep fried, many seek to limit or avoid consumption of potato chips for health reasons.

Baked potato chips are one alternative to the traditional deep fried potato chips. Baking, however, typically requires the use of oil to coat the cooking surface so as to prevent the potato chips from sticking to the pan or other cooking surface.

The use of microwaves to prepare potato chips has been proposed as yet another alternative. For example, U.S. Pat. No. 5,389,768 discloses a circular microwavable potato chip maker that is molded of a plastic material and having a row of spacers defining slots between each adjacent pairs of spacers. The potato chip are positioned vertically in the slots in a spaced array to facilitate their cooking in a microwave oven.

The disadvantage of the plastic microwavable potato chip maker, however, is that the potato chip slices must be arranged on its side and larger or thin slices may fold down upon itself. Moreover, there is a risk that the potato chips may stick to the surface of the plastic material during cooking. Additionally, plastic materials are prone to burning at high temperatures and which, in turn, may result in the release of harmful toxins.

Moreover, plastic microwavable potato chip makers may not be suited for other types of cooked or crisped food, such as fruit or vegetable chips or fries, as these items typically have a size, width or dimension that is unsuitable for such a device.

### BRIEF SUMMARY

The present disclosure provides a cooking implement that may be used to cook and crisp a variety of foods in a microwave. The cooking implement permits efficient heat transfer by providing a cooking surface that is made of a silicone material. Silicone material has superior release characteristics which prevent foods from sticking thereon. This is particularly advantageous for thinly-sliced food items, such as fruit and potato chips, which typically require delicate handling. Thus, the cooking implements and methods for using the cooking implements are advantageous in that its use in cooking or crisping food does not require the addition of oils or other ingredients other than the food item being crisped.

The configuration of the cooking implement provides for a pattern of air circulation that allows food items of a wide range of sizes, shapes and dimensions to attain a desirably crispy texture when cooked. A support system is provided such that air circulation is provided on both sides of the cooking surface. A plurality of holes may be provided to further increase air circulation and thus allow for the food thereon to be cooked and even crisped.

The cooking implement is also configured such that multiple cooking implements may be stacked on top of one another, thereby increasing the quantity of food items cooked in a single cooking cycle.

In one embodiment, the cooking implement comprises a resilient cooking surface, a peripheral rim surrounding the resilient cooking surface, a frame configured couple to the peripheral rim, and a support structure. The frame imparts a tensile strength across the resilient cooking surface when coupled to the peripheral rim and the support structure is configured to support the resilient cooking surface and allow a circulating air space underneath the resilient cooking surface

In another embodiment, the cooking implement comprises a resilient cooking surface, a peripheral member coupled to the resilient cooking surface; and a support structure configured to provide an air space beneath the resilient cooking surface. A tensile force is imparted across the resilient cooking surface by stretching the resilient cooking surface caused by either one or both of the peripheral member and/or the support structure.

In yet another embodiment, the cooking implement comprises a resilient cooking surface, a periphery surrounding the resilient cooking surface, a substantially rigid frame and a support structure supporting the resilient cooking surface above the ground and allowing a circulating air space underneath the resilient cooking surface. The periphery is characterized as having an outermost first dimension and the substantially rigid frame has a second dimension that is different from the first dimension of the periphery. A tensile force is imparted across the resilient cooking surface by coupling the periphery and the substantially rigid frame.

In a further embodiment, a plurality of cooking implements may be stacked on top of one another by having a first perimeter defined by the support structure less than a second perimeter defined by an outer peripheral lip.

A method of crisping food items is further provided. The method comprises placing a layer of a food item on top of a resilient cooking surface of a cooking implement and heating the cooking implement with the food items for a predetermined time. The predetermined time may depend on any one or more of at least the power of the microwave oven, the thickness of the food items, and desired amount of crispiness. The cooking implement is characterized as having a resilient cooking surface maintained at tension by a rigid frame coupled to a periphery surrounding the resilient cooking surface. The cooking implement further comprises a support structure to elevate the resilient cooking surface at a distance above the ground to allow a circulating air space underneath the resilient cooking surface and the resilient cooking surface further comprises a plurality of holes to allow air circulation therethrough to further facilitate crisping of the food items placed thereupon.

In accordance with one aspect of the method, the food items are uncooked potato slices having a thickness of less than 5 mm.

In accordance with a second aspect of the method, a single layer of uncooked potato slices is placed on top of the resilient cooking surface.

In accordance with a third aspect of the method, the heating is performed by a microwave at 600 to 1500 watts for 10 seconds to 12 minutes.

Other objects, features and advantages of the present invention will become apparent to those skilled in the art from the following detailed description.

### BRIEF DESCRIPTION OF THE DRAWINGS

Illustrative embodiments of the present invention are described herein with reference to the accompanying drawings, in which:

FIG. 1 is a perspective view of an embodiment of the cooking implement.

FIG. 2 is an exploded perspective view of the cooking implement of FIG. 1.

FIG. 3 is a top elevational view of the cooking implement of FIG. 1

FIG. 4 is a cross-sectional view of the cooking implement along A-A of FIG. 3.

FIG. 5 is a side elevational view of the cooking implement of FIG. 1.

FIG. 6 is a bottom view of the cooking implement of FIG. 1.

FIG. 7 shows multiple cooking implement stacked on top of one another.

Like numerals refer to like parts throughout the several views of the drawings.

### DETAILED DESCRIPTION OF THE PREFERRED EMBODIMENTS

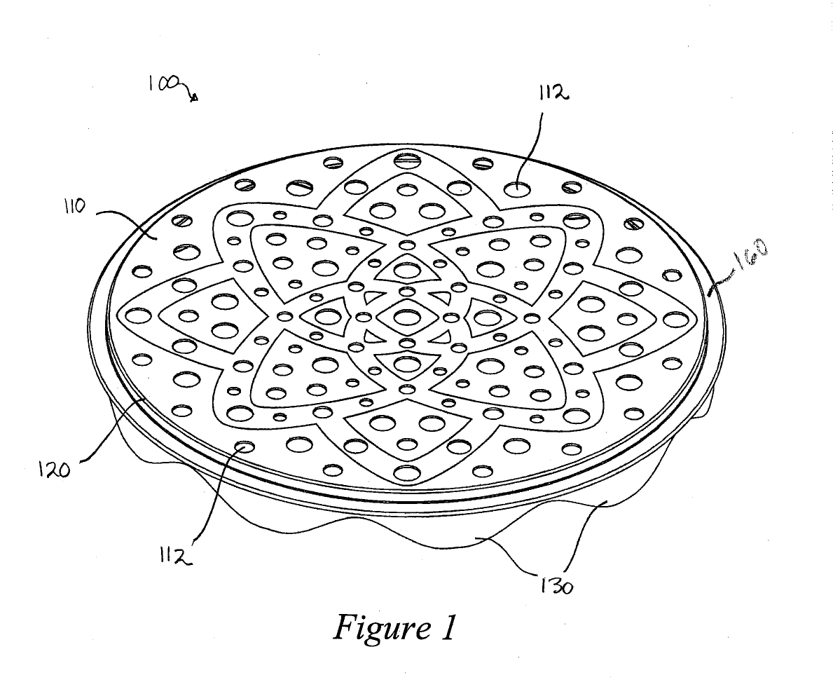

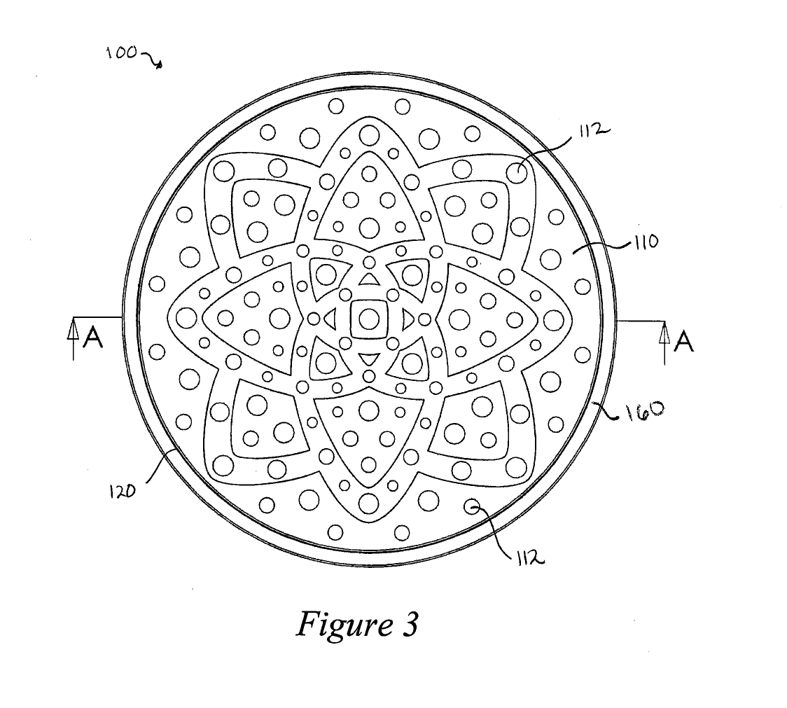

Reference is made to FIGS. 1-6 which illustrate a non-limiting preferred embodiment of the cooking implement 100.

The cooking implement 100 is depicted as generally comprising a resilient cooking surface 110, a periphery 120 surrounding the resilient cooking surface 110, and a plurality of supports 130. The periphery 120 is coupled to a frame 140. The coupling of the periphery 120 to the frame 140 imparts a tensile force across the resilient cooking surface 110 such that an air space is provided underneath when weighted with food items.

The resilient cooking surface 110 may be made of any heat-resistant elastomeric material which preferably is capable of withstanding temperatures above at least 140° C. In a particularly preferred embodiment, the resilient cooking surface 110 consists solely of a thin silicone membrane. In a preferred embodiment, the thickness of the resilient cooking surface 110 is less than 5 mm and more preferably between 0.5 mm and 2.0 mm in an unstretched state. Because the silicone membrane is relatively thin, it allows for efficient heat transfer. The thin silicone membrane is stretched by virtue of coupling the periphery to a rigid frame and/or support. In a particularly preferred embodiment, the stretching and thus the tensile force that is imparted across the thin silicone membrane is sufficient to support the weight of up to 5 kg/cm² without substantial deformation of the thin silicone membrane. This permits the thin silicone to fully support and suspend the food items and allow for efficient heat transfer and crisping by permitting air circulation both above and below the thin silicone membrane.

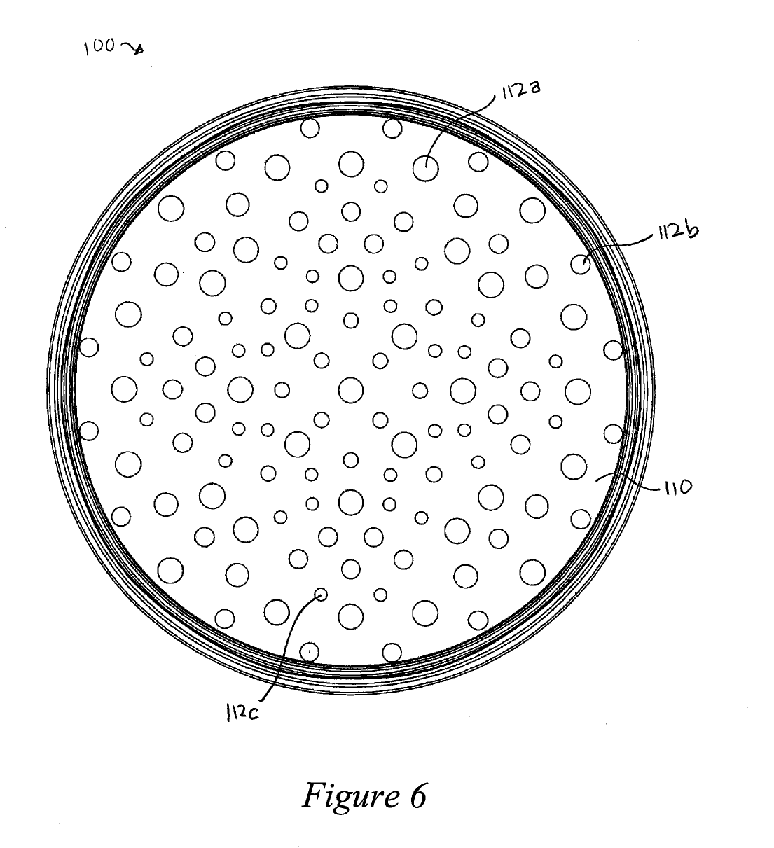

A plurality of holes 112 may be provided on the resilient cooking surface 110 to further enhance the heat transfer and provide a pattern of air circulation therethrough. Although FIGS. 1-7 depict the plurality of holes 112 as having a circular shape, it is understood that the plurality of holes 112 may be of any geometric configuration (e.g., triangular, rectangular, etc.) or combinations thereof. Moreover, as more clearly depicted in FIG. 6, the plurality of holes 112 may be of varying sizes or diameters 112a, 112b and 112c. The size and geometric shape of the plurality of holes 112 may be chosen based on the types of food items for which the cooking implement 100 may be designed to cook and crisp. Larger or thicker food items may require larger holes, whereas smaller or thinner food items may require smaller holes.

While the resilient cooking surface 110 is depicted as having a substantially flat surface, it may also have a non-flat surface and may include waves or other structural designs and/or textures on one or both sides. In particular, with various non-flat designs, different patterns of air circulation may be provided.

The periphery 120 surrounds the resilient cooking surface 110. In one embodiment, the periphery 120 may be generally contiguous with the resilient cooking surface 110. In another embodiment, the periphery 120 may be a separate structure that is coupled to the resilient cooking surface 110.

The periphery 120 has either the same or a greater thickness as the resilient cooking surface 110 when it is unstretched. In a preferred embodiment, the periphery 120 comprises a silicone exterior that is contiguous with the resilient cooking surface 110. In one embodiment, the periphery has a thickness that is sufficient to support the frame 140 and allow a tensile force to be imparted onto the resilient cooking surface 110. In an alternative embodiment, the periphery 120 may further comprise a reinforcement that renders it more rigid than the resilient cooking surface. The reinforcement may be comprised of any material that imparts rigidity, such as a polyamide (e.g., Nylon or Zytel), liquid crystal resins (e.g., Zenite), or combinations thereof.

The periphery 120 is preferably shaped to as to couple either one or both of the support structure 130 or the frame 140. In the preferred embodiment depicted in FIGS. 1-6, the periphery 120 is defined as a area bounded by the resilient cooking surface 110 and a circumferential rim projecting downwardly at about a 90 degree angle from the resilient cooking surface and terminating in a circumferential lip 125. The frame 140 is configured to fit within the space bounded between the resilient cooking surface 110 and the circumferential lip 125 and to exert a outward radial force against the periphery 120 and therefore impart a tensile force across the resilient cooking surface 110.

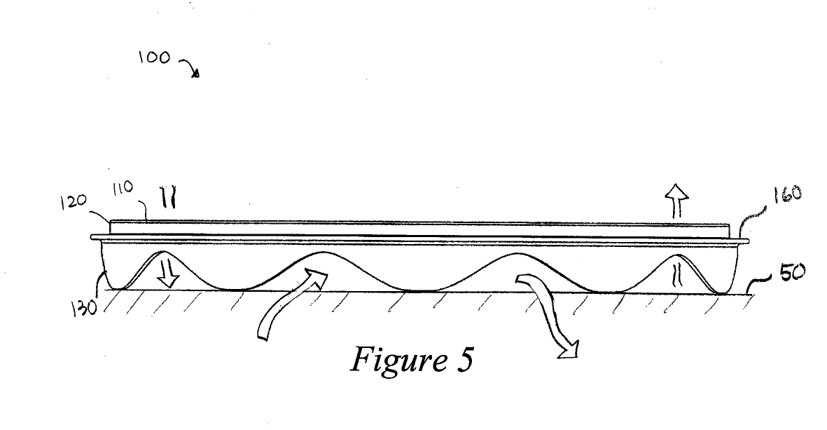

The support structure 130 is further associated with the cooking implement 100 so as to elevate the resilient cooking surface 110. The support structure 130 allows a circulating air space underneath the resilient cooking surface 110. As further depicted in FIG. 5, the support structure 130 may comprise a plurality of legs projecting downwardly from the resilient cooking surface 110 so as to elevate the resilient cooking surface 110 above the surface 50 on which it rests. In this configuration, air is permitted to circulate both into and outside of the area underneath the resilient cooking surface 110. Moreover, the plurality of holes 112 permit further air to circulate across the resilient cooking surface 110. The circulation of air during cooking is what permits the foods cooked on top of the resilient cooking surface 110 to achieve a crispy texture.

The support structure 130 preferably has a silicone exterior and may further have a reinforcement as described with respect to the periphery to impart additional rigidity. Alternatively, the support structure 130 may be comprised solely of silicone having sufficient thickness to impart sufficient rigidity to support the resilient cooking surface 110 when it is weighted with up to 5 kg/c,² of food items.

The height of the support structure 130 is such that it provides sufficient clearance and air space underneath the resilient cooking surface 110 when weighted with food items placed on top of the resilient cooking surface 110. The height of the support structure 130 therefore depends on the amount of tensile force exerted onto the resilient cooking surface 110 and may range anywhere between 5 mm to 10 cm. The greater the tensile force exerted onto the resilient cooking surface 110, the lower the height required of the support structure 130 to maintain adequate airspace underneath the resilient cooking surface 110.

The frame 140 may be constructed of any rigid or substantially rigid material that is also resistant to temperature. The frame 140 is preferably made of a high temperature thermoplastic or a metal that is capable of resisting temperatures of over at least 140° C. The frame may also be made of a polypropylene material that is sufficient thermally resistant. The frame is configured to couple to the periphery 120 and impart a tensile force across the resilient cooking surface 110. The frame 140 may be the same or different shape as the periphery 120.

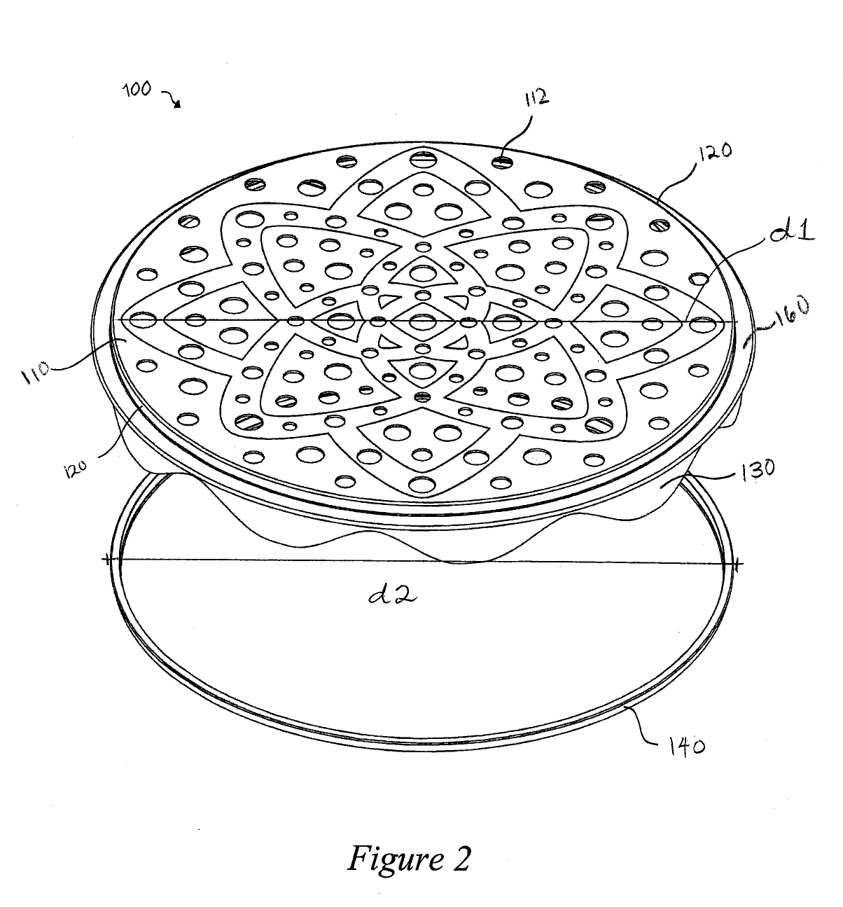

In one embodiment, the frame 140 has the same shape as the periphery 120. In the embodiments depicted in FIGS. 1-6, wherein the shape is substantially circular, a radial tensile force may be exerted across the resilient cooking surface 110 by coupling the periphery 120 onto the frame 140 to cause a stretching of the resilient cooking surface 110. For example, the frame 140 may have a dimension that is larger than the dimension of the periphery 120. In accordance with this embodiment, as shown in FIG. 2, the diameter of the frame 140 (d2) may be larger than the diameter of the periphery 120 (d1). Preferably, the ratio of the diameters of the periphery to that of the frame (d1:d2) is in the range of 0.50 to 0.99, and more preferably from 0.80 to 0.99. The tensile force exerted on the resilient cooking surface 110 is preferably such that it supports a weight of up to 1 kg/cm², and more preferably up to about 5 kg/cm² without substantial deformation of the resilient cooking surface 110. Substantial deformation of the resilient cooking surface 110 is understood to mean the degree of deformation such that it contacts the surface upon which the support structure 130 rests.

In another embodiment, the frame 140 may have a different shape than the periphery 120. The difference in shapes may allow for the tensile force to be imparted across specific dimensions. For example, in one embodiment, the frame 140 may be an oval shape or rectangular shape, whereas the periphery 120 may be of a circular shape, such that when the periphery 120 is stretched over the frame 140, a tensile force is exerted in substantially in two directions.

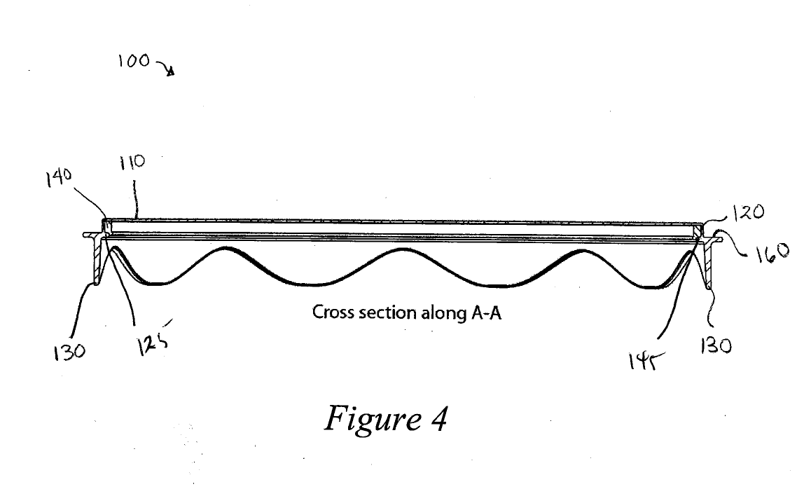

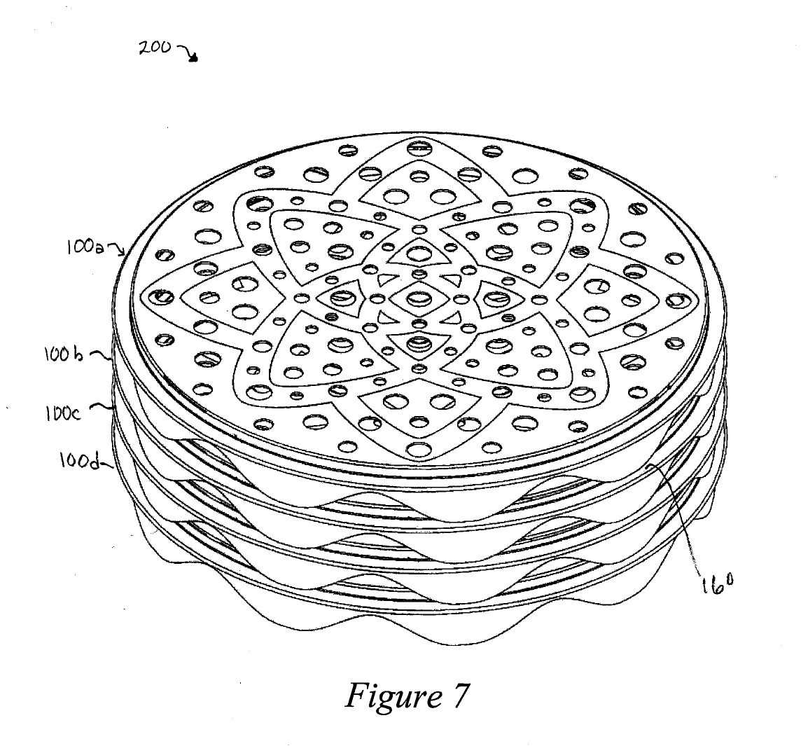

An external circumferential lip 160 may be provided that extends beyond the outer perimeter of the support structure 130. The external circumferential lip 160 may be provided to allow multiple cooking implements 100 to be stacked on top of one another. FIG. 7 shows a stacked assembly of four cooking implements 100a-d, wherein the respective support structures 130 are depicted as resting on top of the external circumferential lips 160 of the cooking implement 100. The external circumferential lip 160 is more clearly depicted in FIGS. 4-5 as extending beyond the perimeter of the support structure 130. The support structure 130 preferably define a circumference that is smaller than the external circumferential lip 160 so that the support structure 130 may comfortable rest on top of the external circumferential lip 160 in the stacked configuration.

In a preferred embodiment, the cooking implement 100 comprises two main pieces—a first piece comprising the resilient cooking surface 110, periphery 120, support structures 130 and a second piece comprising the frame 140. The first piece may be completely made of silicone or may comprise additional reinforcements or other materials. In a particularly preferred embodiment, the entire external surface of the first piece comprises silicone.

In yet another embodiment, the above-described first and second pieces may be a single integral structure.

In yet a further embodiment, each one of the resilient cooking surface 110, periphery 120, support structures 130 and frame 140 may be separate components which are coupled to one another by methods known in the art.

The cooking implement 100 described herein may be used to cook and crisp a variety of different food items, such as potato chips, apple chips, French fries, and almost any kind of food item for which a crispy texture is desired.

To that end, a method is provided of cooking and crisping food items. In a preferred embodiment, a single layer of a food items is placed on top of the resilient cooking surface 110 and the cooking implement with the food items are heated for a predetermined period of time, depending on the food items and the desired level of cooking and/or crisping. Surprisingly impressive results have been obtained particularly with respect to producing potato chips. In a preferred embodiment, uncooked potato slices having a thickness of less than 5 mm, and more preferably less than 2 mm, may be placed on top of the resilient cooking surface 110 and heated in a microwave oven at 600 to 1500 Watts for 10 seconds to 15 minutes or until the desired amount of cooking or crisping is attained.

It is to be understood that the detailed description and specific examples, while indicating preferred embodiments of the present invention, are given by way of illustration and not limitation. Many changes and modifications within the scope of the present invention may be made without departing from the spirit thereof, and the invention includes all such modifications.

What is claimed is:

1. A cooking implement comprising:
a resilient cooking surface;
a peripheral rim surrounding the resilient cooking surface;
a frame configured couple to the peripheral rim and impart a tensile force across the resilient cooking surface; and
a support structure supporting the resilient cooking surface and allowing a circulating air space underneath the resilient cooking surface

2. The cooking implement of claim 1, wherein the resilient cooking surface, the peripheral rim and the support structure is made of silicone.

3. The cooking implement of claim 2, wherein the peripheral rim extends downwardly from the resilient cooking surface and is shaped to couple the frame.

4. The cooking implement of claim 3, wherein the peripheral rim is defined as an area configured to fit the frame, the area bounded by the resilient cooking surface and an inwardly projecting lip.

5. The cooking implement of claim 1, wherein a first dimension defining the frame is larger than a second dimension defining the peripheral rim and wherein a tensile force across the resilient cooking surface is imparted by coupling peripheral rim onto the frame to cause a stretching of the resilient cooking surface.

6. The cooking implement of claim 1, wherein the resilient cooking surface further comprises a plurality of holes to permit air to circulate across the resilient cooking surface.

7. A cooking implement comprising:
a resilient cooking surface;
a periphery surrounding the resilient cooking surface and an outermost first dimension; and
a substantially rigid frame having a second dimension that is different from the first dimension of the periphery;
a support structure supporting the resilient cooking surface above the ground surface and allowing a circulating air space underneath the resilient cooking surface
wherein a tensile force is imparted across the resilient cooking surface by coupling the periphery and the substantially rigid frame.

8. The cooking implement of claim 7, wherein the resilient cooking surface is configured to support a weight of from about 1 to about 5 kg/cm².

9. The cooking implement of claim 7, wherein the substantially rigid frame is made of thermally resistant material.

10. The cooking implement of claim 7, wherein the periphery and the frame have different shapes.

11. The cooking implement of claim 7, wherein the periphery and the frame have the same shape.

12. The cooking implement of claim 11, wherein the frame and the periphery have a circular shape and wherein a first diameter of the periphery is larger than a second diameter of the frame and wherein the tensile strength is imparted radially across the resilient cooking surface when the periphery and the substantially rigid frame are coupled together.

13. The cooking implement of claim 12, wherein a ratio of the first diameter of the periphery to the second diameter of the frame is in the range of from 0.50 to 0.99.

14. The cooking implement of claim 7, wherein the support structure comprises a plurality of legs to allow air to circulate therethrough.

15. The cooking implement of claim 14, wherein the plurality of legs are disposed at an angle relative to the resilient cooking surface.

16. The cooking implement of claim 15 further comprising an outwardly projecting lip extending radially beyond the resilient cooking surface and the support structure.

17. A method of crisping food items comprising:
placing a layer of a food item on top of a resilient cooking surface of a cooking implement, the resilient cooking surface being maintained at tension by a rigid frame coupled to a periphery surrounding the resilient cooking surface, the cooking implement further comprising a support structure to elevate the resilient cooking surface at a distance above the ground to allow a circulating air space underneath the resilient cooking surface, the resilient cooking surface further comprising a plurality of holes to allow air circulation therethrough; and
heating the cooking implement with the food items for a predetermined period of time.

18. The method of claim 17, wherein the food items are uncooked potato, fruit and/or vegetable slices having a thickness of less than 5 mm.

19. The method of claim 18, wherein a single layer of the food items is placed on top of the resilient cooking surface.

20. The method of claim 1, wherein the heating is performed by a microwave at 600 to 1500 watts for 10 seconds to 12 minutes.
